(19) United States
(12) Patent Application Publication
(10) Pub. No.: US 2019/0273618 A1
(43) Pub. Date: Sep. 5, 2019

(54) FAKEOUT© Software System - An electronic apostille-based real time content authentication technique for text, audio and video transmissions

(71) Applicant: Roger G. Marshall, Kinderhook, NY (US)

(72) Inventor: Roger G. Marshall, Kinderhook, NY (US)

(21) Appl. No.: 15/911,691

(22) Filed: Mar. 5, 2018

(51) Int. Cl. H04L 9/32; H04L 29/06; G06F 21/16

(52) U.S. Cl. CPC H04L 9/3247; G06F 21/16; H04L 63/0876; H04L 63/123

(57) ABSTRACT

Electronic versions of apostilles created in real time are used to enhance video, audio and text data streams generated by a transmitting device prior to their transmission over a computer or TV broadcast network to a receiving device. Unlike ordinary apostilles which do not verify the contents of documents being attested, the contents of the electronic apostilles that have been designed are based on the real time video, audio and text content as well as the media access control address data of the transmitting device. The electronic apostille streams which are stored at the transmitting end as they are generated in real time can be compared against the apostille streams at the receiving end to establish if any of the video, audio and text data have been modified.

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### CROSS-REFERENCE TO RELATED APPLICATIONS

Does not apply.

### REFERENCE TO TABLE OR COMPUTER PROGRAM LISTING

Does not apply.

### BACKGROUND OF THE INVENTION

The invention relates to the creation of electronic fingerprints of all data (text, audio and video) posted on the web, especially audio and video posted using social media (but not restricted to social media), with the goal of addressing the prevalence of ‘Fake News’.

Any individual or organization X can download genuine text including email, audio and video data posted by some other individual or organization Y, alter the contents of this data and then upload the ‘new’ data onto the web for viewing by others. This has the potential to cause significant problems for Y and others (such as the followers of X in a social media setting). These significant problems include, for example, physical and verbal violence directed at specific individuals or groups, either creating or stoking ethnic, religious and political tensions, and possibly influencing the outcome of elections at the local, state and federal levels.

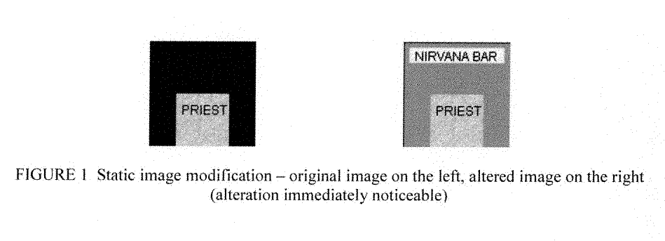

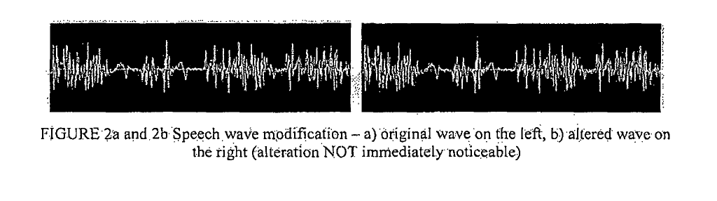

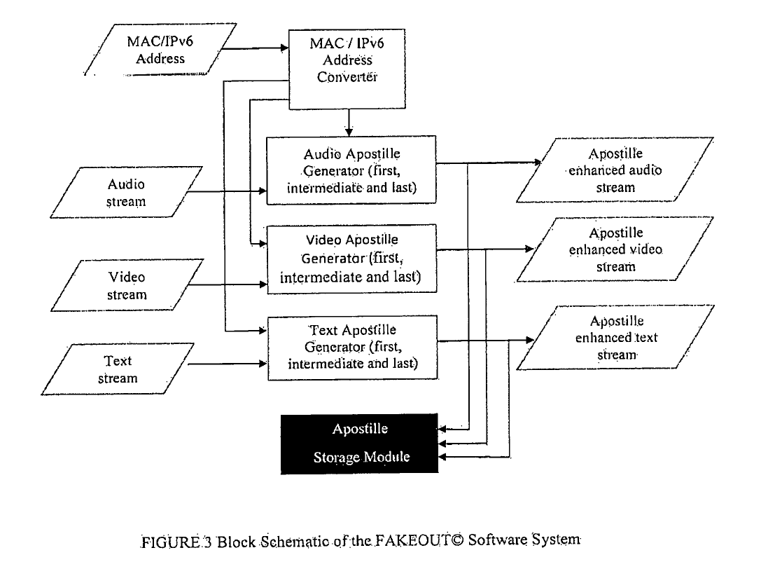

Two specific examples of current technological capabilities in producing fake data in an audio-visual setting are provided. The first example involves altering visual imagery to defame an individual. If the original image shows a priest in front of a church, the background can be changed to that of a disreputable bar so that a viewer of the altered image is left with a negative impression of the priest. See FIGS. 1a and 1b. The almost universal availability of Adobe's Photoshop has made it possible for almost anyone with even a limited technical background to alter static images to suit their purposes, good or bad. The second example involves the alteration of audio data, specifically speech. In President Kennedy's famous inaugural speech, he said “And so, my fellow Americans, ask not what your country can do for you but what you can do for your country”. This utterance can very easily be altered using widely available software to “And so, my fellow Americans, ask what your country can do for you, not what you can do for your country” to give the utterance a totally different meaning. The wave patterns for the original and altered versions are shown in FIGS. 2a and 2b. Text alteration is also extremely easy. For example, if an image depicts a street sign which reads ‘Lovers Lane’, an altered version of the image might display the same sign that now reads ‘Losers Lane’. It should be noted that a significant amount of text data transmitted on the internet are email messages. In the three examples just cited the fake versions have been created from old, i.e. existing, data. Recently published reports from various university and corporate research labs indicate that new software is being developed to enable the modification of speech and visual imagery in real time using face animation algorithms and mimicry techniques [See http://www.radiolab.org/story/breaking-news/]. When such software becomes commonly available, the creation of fake audio and visual information will become exceedingly common. Moreover, the fakes will be so realistic that, unless extremely sophisticated detection tools are available, it will be very difficult to distinguish the fake versions from the original ones. Therefore, it is imperative to come up with techniques that can combat the growing issue of fake news which are electronically spread almost instantaneously, especially via social media.

In the US and elsewhere, the practice of notarizing a physical document within a country's borders to certify the authenticity of the document is well known. Likewise, for a document issued in one country to be recognized as valid in another country, an apostille is usually required. According to the 1961 Hague Convention, an apostille is a pre-printed small (minimum 9×9 centimeters) form having ten numbered items of information with blank spaces to be filled in by the designated authority in the issuing country. It is obligatory upon every signatory country to accept apostilles of the other signatory countries. The ten items are 1) the country where the apostille is generated, 2) identity of the person signing the apostille, 3) in what capacity, 4) seal or stamp of authority and certified at 5) place of issue, 6) date of issue, 7) by whom, 8) identification number, 9) seal or stamp of apostille issuing authority, and 10) signature of person indicated in item 2.

It is important to note that neither an apostille nor a notary's stamp on a document says anything about the contents of the document per se; they merely acknowledge or certify the existence of the document.

The problem addressed by the invention is one of data content manipulation, not one of data transmission. This is because errors in data transmission are typically handled through parity checks, block sums and cyclic redundancy checks which are all well-known techniques and quite standard in the fields of information technology and telecommunications. Content verification and validation of text, audio and image data using image processing techniques are described in U.S. Pat. No. 9,218,528 B1 (Dec. 12, 2015), U.S. Pat. No. 9,779,256 B2 (Oct. 3, 2017) and U.S. Pat. No. 8,787,626 B2 (Jul. 22, 2014). A scheme for cryptographic encryption and decryption of text, audio and image data is discussed in U.S. Pat. No. 9,544,277 (Jan. 10, 2017). However, while the above patents focus on data content, they only address static versions of text and image data; in the case of audio data, the wave forms of the audio data are considered static in nature and mapped into RGB images. No issues pertaining to real-time transmissions of text, audio and video have been addressed by any of these patents.

### BRIEF SUMMARY OF THE INVENTION

A block schematic of the FAKEOUT© software system is shown in FIG. 3. Streaming text data and audiovisual data generated by a computing device, phone or television signal transmitting station and sent on a wired or wireless network are split into three data streams—a video data stream comprised of digital images, streaming text comprised of just character strings and an audio data stream consisting of sound waves. The video data stream is sent to a video apostille generator module, text data to the text apostille generator module, and the audio data stream to an audio apostille generator module. The MAC/IPv6 address converter module converts a Media Access Control (MAC) address or Internet Protocol (IP) version 6 address into a form suitable for incorporation into an image or an audio wave or character stream. The output of this module is sent to all three apostille generators. The outputs from the apostille modules are then stored at the transmitting end for audit trail purposes. The three apostilles are inserted into the three data streams (labeled ‘apostille enhanced data streams’) before being transmitted to the receiving stations (computers, phones and television).

When text, audio and video data are transmitted in real time for a given time duration, say NT where N is some positive integer, three types of electronic apostilles are generated for each time segment T. There is an apostille (‘video apostille’) for the video part, an apostille for the text part, and one apostille (‘audio apostille’) for the audio part. The audio apostille is always in synchrony with the video one. A total of 3N apostilles are created—N apostilles for each apostille type.

The apostille for any time segment is generated using two types of data—a) the MAC (media access control) or hardware address of the network accessing device, a smartphone or computer using either the Ethernet or Wireless, and b) the actual video and audio content being transmitted or, in the case of email, text strings. Incorporating the MAC address into an apostille ensures the identity of the sender is always known. Instead of using the MAC address, IPv6 addresses can also be used.

The first time segment and the (N+1)^{th} time segments are handled differently from the rest. This is because the apostille for first time segment only contains the MAC/IPv6 address but no actual audio/video/text content (since data transmission hasn't started yet) while the (N+1)^{th} time segment has either one apostille with no data content or two apostille plus a data component. In the latter case we have the apostille of the preceding time segment, the very last video/audio/text data items and the apostille generated from the last few data items. The apostilles are all inserted into the original data stream before transmission.

The text, audio and video data at the receiving end are stored. If there is need for the received data to be authenticated against the transmitting data, then the receiving end data can be input to the FAKEOUT© system to generate the apostille streams for the text, audio and video parts of the input. These apostille streams can then be compared with the ones in the audit trail store using the apostille stream comparator to ascertain if they match. Assuming there have been no errors in data transmission, as soon as the first mismatch is detected there is no need to check the rest of the apostilles since none of these will match. This is because any apostille generated at any time step tₓ is based on the apostille created in the previous time step tₓ₋₁. If the content of any data item (audio, video or text) has been altered in any given time step, this is immediately reflected in the apostille at the next time step. This means precise information is available on when the data tampering occurred.

The complete procedure for generating the various types of apostilles is fully discussed in the ‘Detailed Description of the Invention’ section of the Specification.

### BRIEF DESCRIPTION OF THE SEVERAL VIEWS OF THE DRAWING

“The patent or application contains at least one drawing executed in color. Copies of this patent or patent application publication with color drawing(s) will be provided by the Office upon request and payment of the necessary fee”

The inventor petitions the US Patent Office to permit the usage of color drawings in this patent application since they are essential to the utility of the invention. Visual discrimination of the differences in software system's output for two or more marginally different inputs is rendered possible only through the employment of various shadings and mixtures of red, blue and green colors; such immediate visual discrimination would not be possible using simple black/white or gray scale images.

### LIST OF DRAWINGS

FIGS. 1a and 1b Static image modification—a) original image on the left, and b) altered image on the right (alteration immediately noticeable)

FIGS. 2a and 2b Speech wave modification—a)original wave on the left, and b) altered wave on the right (alteration NOT immediately noticeable)

FIG. 3 Block Schematic of the FAKEOUT© Software System

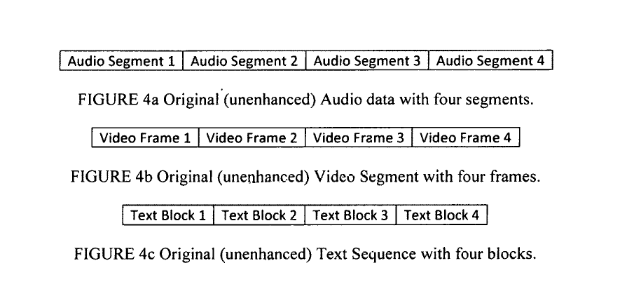

FIG. 4a Original (unenhanced) Audio data with four segments.

FIG. 4b Original (unenhanced) Video Segment with four frames.

FIG. 4c Original (unenhanced) Text Sequence with four blocks.

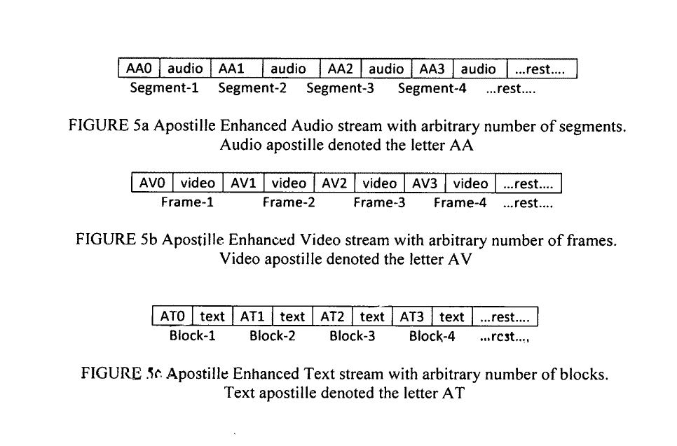

FIG. 5a Apostille Enhanced Audio stream with arbitrary number of segments. Audio apostille denoted the letter AA and highlighted in yellow

FIG. 5b Apostille Enhanced Video stream with arbitrary number of frames. Video apostille denoted the letter AV and highlighted in blue

FIG. 5c Apostille Enhanced Text stream with arbitrary number of blocks. Text apostille denoted the letter AT and highlighted in green

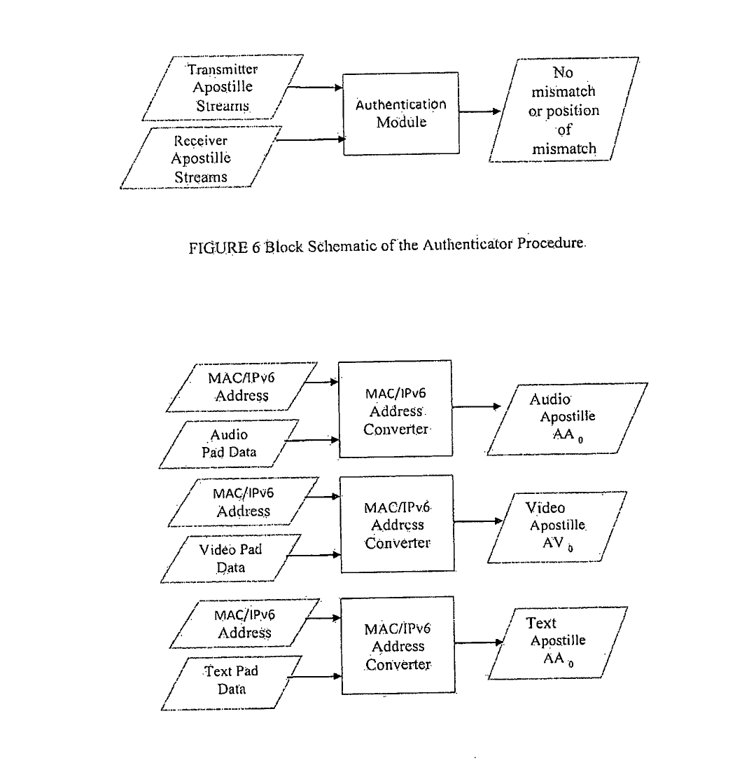

FIG. 6 Block Schematic of the Authenticator Procedure

FIG. 7 MAC/IPv6 Address Converter Module to generate the AA0, AV0 and AT0 apostilles

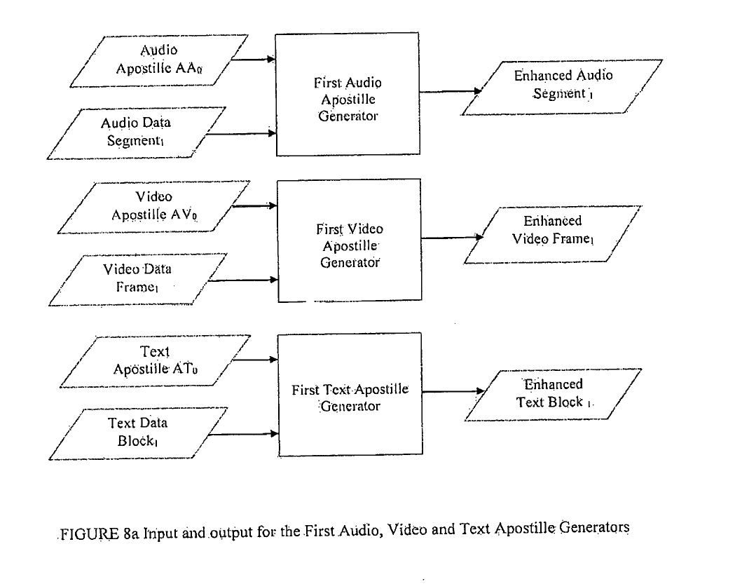

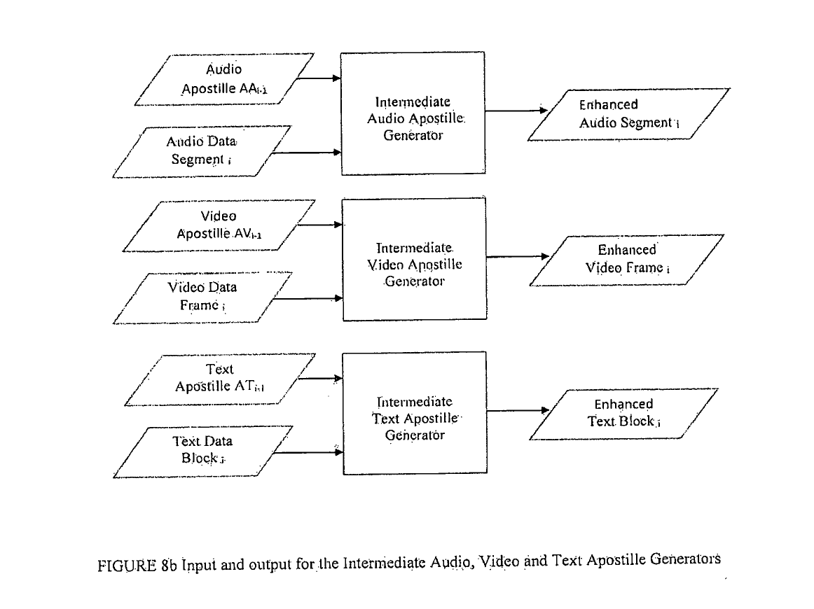

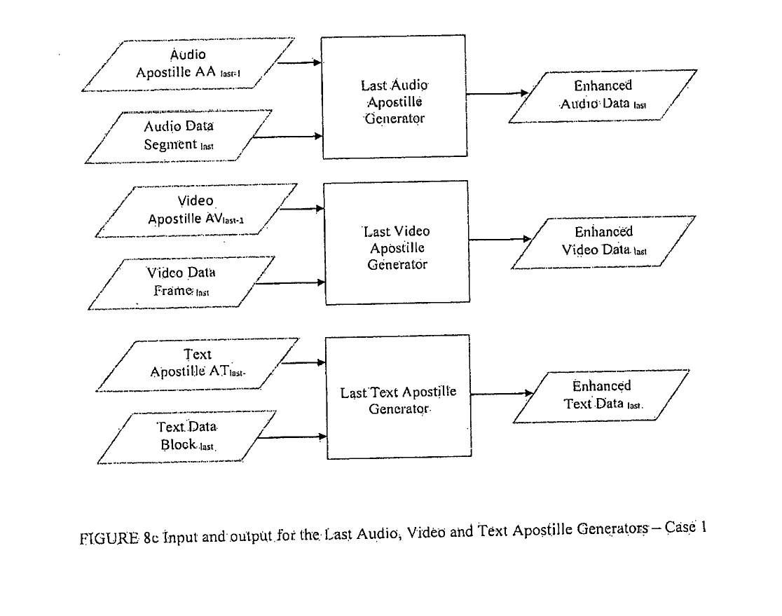

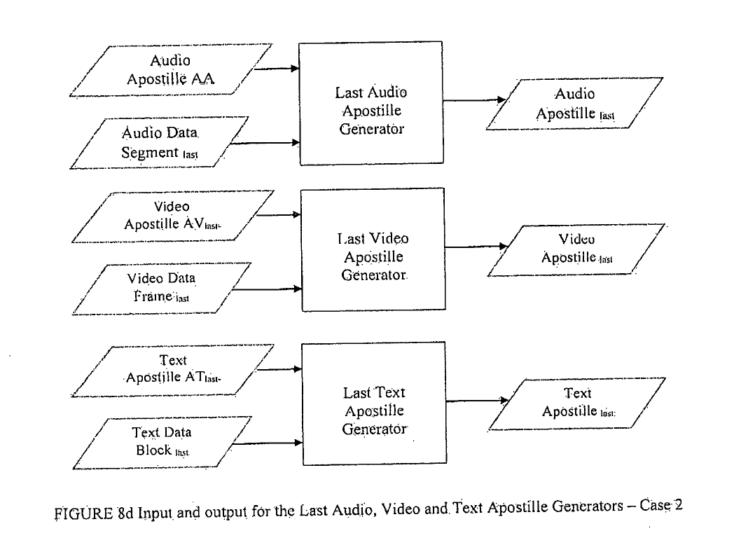

FIG. 8a Input and output for the First Audio, Video and Text Apostille Generators

FIG. 8b Input and output for the Intermediate Audio, Video and Text Apostille Generators

FIG. 8c Input and output for the Last Audio, Video and Text Apostille Generators—Case 1

FIG. 8d Input and output for the Last Audio, Video and Text Apostille Generators—Case 2

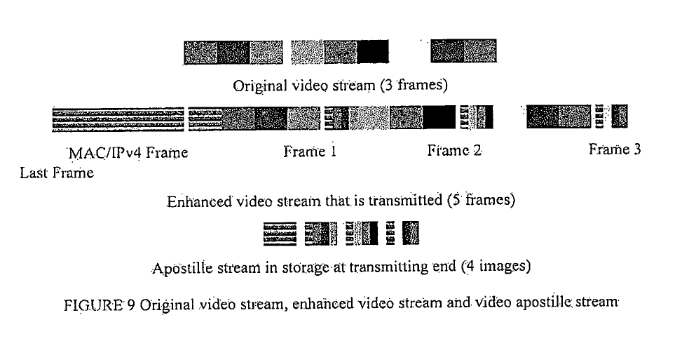

FIG. 9 Original video stream, enhanced video stream and video apostille stream

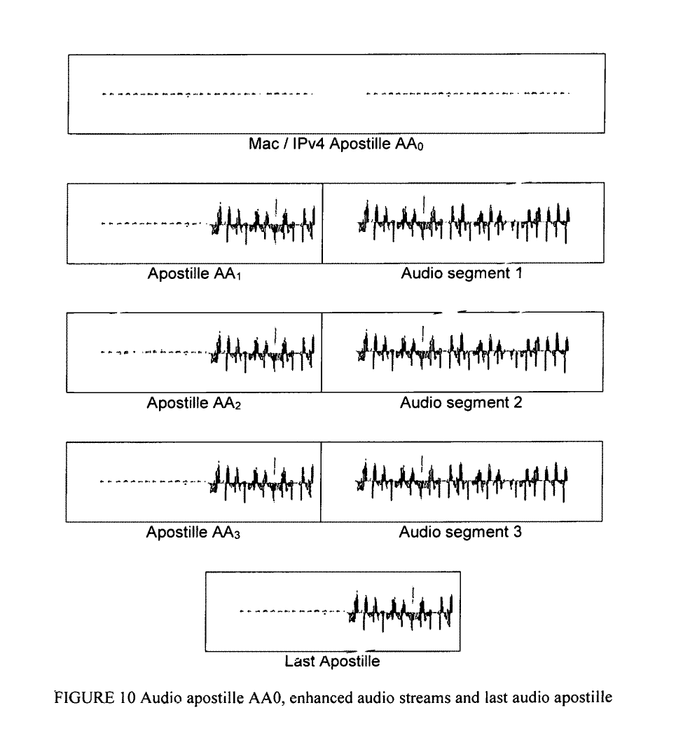

FIG. 10 Audio apostille AA0, enhanced audio streams and last audio apostille

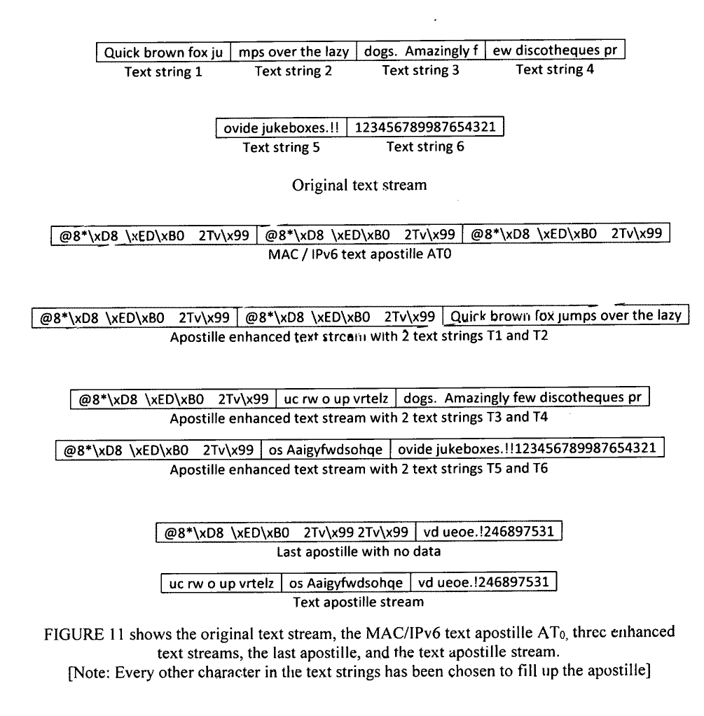

FIG. 11 shows the original text stream, the MAC/IPv6 text apostille AT₀, three enhanced text streams, the last apostille, and the text apostille stream.

[Note: Every other character in the text strings has been chosen to fill up the apostille]

### DETAILED DESCRIPTION OF THE INVENTION

The FAKEOUT© system is comprised of eight distinct software functions—a) MAC/IPv6 address converter, b) image apostille generator, c) audio apostille generator, d) text apostille generator, e) wave normalizer, f) apostilles audit trail store and h) apostille stream comparator. The block schematic of the system is depicted in FIG. 3.

The MAC/IPv6 address converter module is used to generate a portion of each apostille by converting the underlying address into color specifications, Unicode character specifications and wave amplitude specifications. The typical MAC address (hardware address) is a 48-bit address while 64-bit addresses are also used. There is a MAC address for wired networks (Ethernet) and a MAC address for wireless networks, depending on how network access is facilitated. A computing device such as a laptop or smart phone may have more than one MAC address depending on how the communication network is accessed—via Ethernet, wireless or Bluetooth.

The typical IP address has two formulations—IPv4 and IPv6. The IPv4 address is a 32-bit whereas the IPv6 address is a 128-bit address. In this application we only focus on IPv6 addresses. Irrespective of whether an address is 32 bits, 48 bits, 64 bits or 128 bits long (i.e, either 4, 6, 8 or 16 bytes), the numeric value of a byte lies in the (0, 255) range. The value of each color component in a color scheme such as RGB is also in the same range. Likewise, the numeric value of any character in the Unicode character representation is also in the (0, 255) range. Consequently, every MAC or IP address can be interpreted three ways—as a set of characters, a set of color values or a set of wave amplitude values.

The amplitude of every sample in audio data in any time segment is made to lie in the (0, 1) range by the wave normalizer module. If each of the hexadecimal digits in the MAC or IP address is divided by 15, all the values will also be in the (0,1) range. This means any MAC or IP address can be interpreted as a set of samples of an audio wave.

MAC addresses are typically 6 groups of two hexadecimal digits (0 through 9, A through F), separated either by colons or hyphens (e.g., 00:1C:06:25:12). IPv4 are 32-bit addresses which can be written as 4 groups of 2 hexadecimal digits with intervening separator symbols (e.g., FF.AB.05.00). Likewise, IPv6 are 64-bit addresses which can be represented by 8 groups of 4 hexadecimal digits (e.g., AABB.BCCD.1122.7788. CCEE.0045.4444.3322). The examples given are totally arbitrary and need not correspond to any existing MAC or IP address.

By ignoring the separator character, any MAC or IP address can be viewed as a concatenated string of integers where each integer is a value between 0 and 255. In a 24-bit RGB color scheme, the value of a color component (red or green or blue) lies between the minimum of 0 and maximum of 255. Therefore, a MAC address can be viewed as specifying the RGB colors of pixels. The same hex digits of the MAC address can be interpreted as representing the amplitudes of a very short audio wave segment where the smallest and largest values lie between 0 and 15 or, for pairs of hex digits, values in the range (0, 255). Likewise, the MAC address can be viewed as a concatenated string of characters from the Unicode character set since each Unicode character is coded by some integer is a value between 0 and 255. In short, we have the MAC address serving 3 purposes—a) as RGB pixels to be used in generating video apostilles, b) as the amplitudes of a short audio wave when generating audio apostilles, and c) as Unicode characters in generating text apostilles.

### Mathematical Description of Apostille Generation

The apostille generation operations can be concisely described in mathematical terms as the ensuing paragraph shows.

Let P be any type of apostille and D is the data for that apostille type. If Pᵢ represents the i^{th} apostille and Dᵢ represents the data, then, for all intermediate apostilles, we have

Pᵢ=f(Pᵢ₋₁,Dᵢ₋₁)

where i>=2 and ‘f’ is a function specific to the type of apostille created.
If Pᵢ is a video apostille, then Dᵢ is the video data and ‘f’ is the function which combines the RGB interpretation of the MAC/IPv6 address and color values drawn from select columns in the video data Dᵢ. If Pi is an audio apostille, then Dᵢ is the audio data and ‘f’ is the function which combines the wave amplitude interpretation of the MAC/IPv6 address and select wave amplitude from the audio data Dᵢ. Lastly, If Pᵢ is a text apostille, then Dᵢ is text data and ‘f’ is the function which concatenates the 3-character interpretation of the MAC/IPv6 address with select substrings from text data Dᵢ.
The first apostille P₁=g(MAC or IPv6 address).
If P₁ is a video apostille, then ‘g’ is the function which produces a color apostille where the color is the RGB interpretation of the MAC/IPv6 address.

If P₁ is an audio apostille, the ‘g’ is a function that produces a wave whose amplitudes are determined by the normalized value interpretation of the MAC/IPv6 address.

If P1 is the text apostille, then ‘g’ is a function which generates a repetitive character string based on the three Unicode character interpretation of the MAC/IPv6 address.

If Pₗₐₛₜ is the last apostille, there are two cases.

Case 1: Pₗₐₛₜ=f(Pₗₐₛₜ₋₁, Dₗₐₛₜ₋₁) if Dₗₐₛₜ₋₁ has no more data following it.
If P is a video apostille, then Pₗₐₛₜ will be in a separate frame followed by a color representing null.
If P is an audio apostille, then Pₗₐₛₜ will be in a separate segment followed by null, i.e., a zero-amplitude wave.
If P is a text apostille, then Pₗₐₛₜ will be in a separate block followed by a stream of null characters.
Case 2: Pₗₐₛₜ=f(Pₗₐₛₜ₋₁, Dᵣₑₛₜ) where the size of Dᵣₑₛₜ is such that it cannot fill the whole space allocated to it.
If P is a video apostille, then Pₗₐₛₜ₋₁ and Pₗₐₛₜ will be in the same frame separated by video data Dᵣₑₛₜ. Pₗₐₛₜ will be then followed by a color representing null.
If P is an audio apostille, then Pₗₐₛₜ₋₁ and Pₗₐₛₜ will be in the same segment separated by audio data Dᵣₑₛₜ. Pₗₐₛₜ will be then followed by a zero-amplitude wave.
If P is a text apostille, then Pₗₐₛₜ₋₁ and Pₗₐₛₜ will be in the same block separated by character data Dᵣₑₛₜ. Pₗₐₛₜ will be then followed by a string of null characters.
Creating Apostille-Enhanced Data Streams from Original Data Streams

The original audio, video and text data streams are shown in FIGS. 4a, 4b and 4c, respectively. The ‘apostille enhanced’ audio, video and text data streams are all shown in FIGS. 5a, 5b, 5c [audio data stream], 6a, 6b, 6c [video data stream], and 7a, 7b and 7c. [text data stream].

### Audio Apostilles

We assume all segments of the audio wave are of the same length and that each segment contains L samples. Each of the audio apostilles that are generated will be of length L.

Creating the first audio apostille: The normalized values of the MAC or IPv6 address are replicated as many times as required so that there is a total of L values.

Creating the intermediate audio apostilles: Here the first k values are the normalized values of the MAC or IPv6 address, followed by (L−k) values taken from the audio data in the previous segment.

Creating the last audio apostille: Here there are two possibilities. If the previous frame containing one apostille is followed by the rest of the audio data which fits into the audio segment exactly and there is no more audio data to follow, the next segment will contain exactly one apostille and no data following it. The other possibility is when the last frame has one apostille followed by some audio data but not enough to fill the segment. In this case, a second apostille will be created to account for the last few audio items.

### Video Apostilles

We assume all frames are of the same size and that each frame is comprised of equal sized images and each image is of width W and height H. Each of the video apostilles that are generated will be of width W and height H. So, each apostilles represents a matrix with H rows and W columns.

Creating the first video apostille: The apostille will contain W×H pixels and the color values of the pixels are given by the RGB values of the MAC or IPv6 address. So, the apostille will be have a unique color combination. Label this color C.

Creating the intermediate video apostilles: The first k columns of any intermediate apostille will have color C. The remaining (W−k) columns are filled in with data from various columns of images from the previous frame.

Creating the last video apostille: Here there are two possibilities. If the previous frame containing one apostille is followed by the rest of the video data which fits into the frame exactly and there is no more video data to follow, the next frame will contain exactly one apostille and no data following it. The other possibility is when the last frame has one apostille followed by some video data but not enough to fill the frame. In this case, a second apostille will be created to account for the last few video items.

### Text Apostilles

We assume all blocks in the text message are of the same length and that each block contains M characters. Each of the text apostilles that are generated will be of length L.

Creating the first text apostille: The Unicode characters representing the MAC or IPv6 address are replicated as many times as required so that a total of L characters is obtained.

Creating the intermediate text apostilles: Here the first k values are the Unicode characters of the MAC or IPv6 address, followed by (L−k) values taken from the text data in the previous block.

Creating the last audio apostille: Here there are two possibilities. If the previous block containing one apostille is followed by the rest of the text data which fits into the text block exactly and there is no more text data to follow, the next block will contain exactly one apostille and no text data following it. The other possibility is when the last block has one apostille followed by some text but not enough to fill the block. In this case, a second apostille will be created to account for the last few text items.

Creating the last text apostille: Here there are two possibilities. If the previous frame containing one apostille is followed by the rest of the video data which fits into the frame exactly and there is no more video data to follow, the next frame will contain exactly one apostille and no data following it. The other possibility is when the last frame has one apostille followed by some video data but not enough to fill the frame. In this case, a second apostille will be created to account for the last few video items.

The following example illustrates how a video apostille is created. Consider video frames X, Y and Z where each frame has 32 columns. Assume each frame contains 4 images and each image, in turn, has 6 rows and 8 columns (i.e., images of width 8 pixels and height 6 pixels). Video frame X contains an apostille XA followed by images XD1, XD2 and XD3. Video frame Y contains an apostille YA followed by images YD1, YD2 and YD3. The first image in frame Y is the apostille (8 columns) which is followed by 3 video data images (each having 8 columns). YA is formed by picking two columns each from XA, XD1, XD2 and XD3—a total of 8 columns. Likewise, ZA is formed by picking 2 columns each from YA, YD1, YD2 and YD3.

The next example illustrates how an audio apostille is created. Consider audio segments X, Y and Z where each segment has 32 samples. Assume each segment contains 4 sub-segments and each subsegment, in turn, has 8 samples. Audio segment X contains an apostille XA followed by segments XD1, XD2 and XD3. Video segment Y contains an apostille YA followed by segments YD1, YD2 and YD3. The first sub-segment in frame Y is the apostille (8 samples) which is followed by 3 audio sub-segments (each having 8 samples). YA is formed by picking two samples each from XA, XD1, XD2 and XD3—a total of 8 samples. Likewise, ZA is formed by picking 2 samples each from YA, YD1, YD2 and YD3.

The last example illustrates how a text apostille is created. Consider text blocks X, Y and Z where each block has 32 characters. Assume each block contains 4 sub-strings and each sub-string, in turn, has 8 characters. Text block X contains an apostille XA followed by text blocks XD1, XD2 and XD3. Text block Y contains an apostille YA followed by text blocks YD1, YD2 and YD3. The first sub-string in frame Y is the apostille (8 characters) which is followed by 3 sub-strings (each having 8 characters). YA is formed by picking two characters each from XA, XD1, XD2 and XD3—a total of 8 characters. Likewise, ZA is formed by picking 2 characters each from YA, YD1, YD2 and YD3.

### The MAC/IPv6 Apostille Generator Module

This module is responsible for creating apostilles AA0, AV0 and AT0 which are the audio, video and text apostilles, respectively from the MAC or IPv6 address. Since the sizes of the apostilles are always larger than the size of the vector representing audio, video or text versions of the MAC or IPv6 addresses, the vector can be replicated to fill the rest of the apostille. In some cases, one or more elements from the vector will be needed to completely fill the apostille. In such situations, other pad data can be used as well. See FIG. 6.

FIG. 7 show the MAC/IPv6 Address Converter Module which generates the audio, video and text apostilles AA0, AV0 and AT0, respectively. These apostilles are needed to produce all other apostilles in the system. FIG. 8a shows the audio, video and text apostille generators for the first apostilles. FIG. 8b shows the audio, video and text apostille generators for the intermediate apostilles. FIG. 8c shows the audio, video and text apostille generators for the last apostille (case 1), and FIG. 8d shows the audio, video and text apostille generators for the last apostille (case 2).

FIG. 9 show the original video stream, enhanced video stream and video apostille stream in storage at the transmitting node. FIG. 10 shows, for audio data, the audio apostille AA0, enhanced audio stream and last audio apostille. FIG. 11 shows the original text stream, the MAC/IPv6 text apostille AT₀, three enhanced text streams, the last apostille, and the text apostille stream.

In this application, the phrases ‘transmitting device’ and ‘receiving device’ have been used to account for situations in which a video/audio/text data stream from the original transmitting device goes through one or more intermediate nodes to its ultimate destination device. The intermediate nodes are also viewed as transmitting devices. For example, if device X transmits to device Y which, in turn transmits to device Z, the apostille streams generated and stored at X is based on its own Mac/IPv6 address whereas the apostille streams generated and stored at Y will depend on Y's own MAC/IPv6 address.

1. A software system implemented using a computer processor which takes as input a) the Media Access Control (MAC) address or Internet Protocol version 6 (IPv6) address of the transmitting device and b) video, audio and text stream being sent as data in real time through a computer network by the transmitting device and generates c) an electronic apostille stream which is stored at the transmitting device and d) an electronic apostille-enhanced video, electronic-apostille enhanced audio and electronic-apostille enhanced text data stream which is sent to a receiving device, and e) checks if the electronic apostille stream extracted at the receiving end matches the electronic apostille stream stored at the transmitting end.

2. A method according to claim 1 where a video data stream is a time-sequenced set of equal size frames.

3. A method according to claim 2 where each frame is a sequence of same-size images.

4. A method according to claim 3 where the image size is determined by a user of the transmitting device.

5. A method according to claim 1 an audio data stream in claim 1 is a time-sequenced set of audio segments.

6. A method according to claim 5 where each audio segment is a time-sequenced sequence of equal-duration audio signals.

7. A method according to claim 6 the duration of the signal is determined by the user at the transmitting end.

8. A method according to claim 1 where a text data stream is a time-sequenced set of equal-size blocks.

9. A method according to claim 8 where each block has the same number of characters.

10. A method according to claim 1 where the initial (zero-th) electronic apostilles created—one for audio, one for video, one for text—are based only on the MAC address or the IPv6 address of the transmitting device.

11. A method according to claim 10 where the first electronic apostille-enhanced data streams created—one for audio, one for video, one for text—are based the apostilles defined in claim 10 and the first incoming video, audio and text data.

12. A method according to claim 11 where ‘intermediate’ electronic apostille-enhanced video, audio and text streams are created based on claim 10, and the video, audio and test data received in the previous time step.

13. A method according to claim 12 where ‘last’ electronic apostilles based on the very last video, audio and text data received and the apostilles.

14. A method according to claims 10, 11, 12 and 13 where all the apostilles are stored at the data transmitting end for comparison against the apostille stream extracted from the enhanced data stream at the receiving end.

15. A method according to claim 1 where if device X transmits to device Y which, in turn transmits to device Z, the apostille streams stored at X is based on the Mac/IPv6 address of X will be different from the apostille streams at Y since Y is now the transmitter and the apostille streams are based on Y's MAC/IPv6 address.
